(19) United States
(12) Patent Application Publication
(10) Pub. No.: US 2023/0241984 A1
(43) Pub. Date: Aug. 3, 2023

(54) SUPERCAPACITOR AND ELECTROCHEMICAL HYBRID BATTERY WITH DYNAMIC IMPEDANCE MATCHING CAPABILITY

(71) Applicant: SUSTAINABLE ENERGY TECHNOLOGIES. INC., WILMINGTON, DE (US)

(72) Inventor: John Cronin, WILMINGTON, DE (US)

(21) Appl. No.: 18/105,108

(22) Filed: Feb. 2, 2023

Related U.S. Application Data
(60) Provisional application No. 63/305,919, filed on Feb. 2, 2022.

(51) Int. Cl. B60L 50/40; B60L 50/60; B60L 58/10; H02J 7/34; H02J 7/00

(52) U.S. Cl. CPC B60L 50/40; B60L 50/60; B60L 58/10; H02J 7/345; H02J 7/007182; H02J 2310/48

(57) ABSTRACT

Disclosed herein are systems and methods for energy management. A system, such as a vehicle, includes a plurality of energy storage units that include a supercapacitor and an electrochemical battery. The system includes an electric drivetrain configured to propel the vehicle, a plurality of energy storage units including a supercapacitor and an electrochemical battery, and a processor configured to measure physical characteristics associated with at least one of the supercapacitor battery and the EC battery; measure power provided from the EC battery during a period of time; determine an EC power consumption estimate based on the power provided from the EC battery and forecasted power consumption; determine a supercapacitor battery swap condition; and switch a power supply of the vehicle to the supercapacitor battery based on satisfying the supercapacitor battery swap condition.

### CROSS-REFERENCE TO RELATED APPLICATIONS

This application claims the benefit of U.S. Provisional Application No. 63/305,919, filed Feb. 2, 2022, titled “SUPERCAPACITOR AND LEAD-ACID BATTERY HYBRID BATTERY WITH DYNAMIC IMPEDANCE MATCHING CAPABILITY,” the disclosure of which is incorporated herein by reference in its entirety.

### FIELD OF THE DISCLOSURE

The present disclosure is generally related to a supercapacitor and electrochemical hybrid battery with dynamic impedance matching capability used in electric vehicles.

### BACKGROUND

Some vehicles, such as electric vehicles or hybrid vehicles, include energy storage units such as batteries to power components and subsystems of the vehicles. For instance, in some vehicles, power from the energy storage units is used to power propulsion mechanisms, such as motors and/or engines, that propel the vehicle. Such a vehicle's effective driving range can be limited by how much power can be provided by its energy storage units. A supercapacitor is a type of capacitor that can be used as an energy storage unit.

### SUMMARY

Disclosed are systems, apparatuses, methods, computer readable medium, and circuits for operating a vehicle based on a dynamic impedance. According to at least one example, a method includes: According to at least one example, a method includes: measuring physical characteristics associated with at least one of a supercapacitor battery and an EC battery; measuring power provided from the EC battery during a period of time; determining an EC power consumption estimate based on the power provided from the EC battery and forecasted power consumption; determining a supercapacitor battery swap condition to connect the supercapacitor battery based on an impedance model of the supercapacitor battery associated with the physical characteristics; and switching a power supply of the vehicle to the supercapacitor battery based on satisfying the supercapacitor battery swap condition. For example, the electric vehicle measures physical characteristics associated with at least one of a supercapacitor battery and an EC battery; measures power provided from the EC battery during a period of time; determines an EC power consumption estimate based on the power provided from the EC battery and forecasted power consumption; determines a supercapacitor battery swap condition to connect the supercapacitor battery based on an impedance model of the supercapacitor battery associated with the physical characteristics; and switches a power supply of the vehicle to the supercapacitor battery based on satisfying the supercapacitor battery swap condition.

In another example, a electric vehicle for device function is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the electric vehicle to: measure physical characteristics associated with at least one of a supercapacitor battery and an EC battery; measure power provided from the EC battery during a period of time; determine an EC power consumption estimate based on the power provided from the EC battery and forecasted power consumption; determine a supercapacitor battery swap condition to connect the supercapacitor battery based on an impedance model of the supercapacitor battery associated with the physical characteristics; and switch a power supply of the vehicle to the supercapacitor battery based on satisfying the supercapacitor battery swap condition.

### BRIEF DESCRIPTION OF THE DRAWINGS

The accompanying drawings illustrate various systems, methods, and other aspects. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a supercapacitor and electrochemical (EC) hybrid battery with dynamic impedance matching capability in accordance with some aspects of the disclosure.

FIG. 2 illustrates a Base Module in accordance with some aspects of the disclosure.

FIG. 3 illustrates a supercapacitor (SC) controller in accordance with some aspects of the disclosure.

FIG. 4 illustrates a dynamic impedance (DI) module in accordance with some aspects of the disclosure.

FIG. 5 illustrates an equivalent circuit model of a supercapacitor that is used by a device to improve operations in accordance with some aspects of the disclosure.

FIG. 6 is a block diagram illustrating a switch controlled by an energy controller that toggles between a first configuration in which components draw power from an electrochemical battery and a second configuration in which the components draw power from a supercapacitor battery in accordance with some aspects of the disclosure.

FIG. 7 is a block diagram illustrating use of one or more trained machine learning models of a machine learning engine to identify a power draw, for instance to estimate a current power draw or predict a future power draw in accordance with some aspects of the disclosure.

FIG. 8 is a flow diagram illustrating a process to estimate power dissipation at runtime by a device having a heterogeneous battery system in accordance with some aspects of the disclosure.

FIG. 9 is a flow diagram illustrating a process executed by a DI module to improve power consumption by a device having a heterogeneous battery system in accordance with some aspects of the disclosure.

### DETAILED DESCRIPTION

Aspects of the present invention are disclosed in the following description and related figures directed to specific aspects of the disclosure. Those of ordinary skill in the art will recognize that alternate embodiments may be devised without departing from the spirit or scope of the claims. Additionally, known elements of aspects of the invention will not be described in detail or will be omitted so as not to obscure the relevant details of the invention.

Aspects of the present invention are disclosed in the following description and related figures directed to specific embodiments of the invention. Those of ordinary skill in the art will recognize that alternate embodiments may be devised without departing from the claims' spirit or scope. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

Disclosed herein are systems and methods for energy management. A system (e.g., a vehicle) includes energy storage units that include a supercapacitor and an electrochemical battery. The system includes an electric drivetrain configured to propel the vehicle, a plurality of energy storage units including a supercapacitor and an electrochemical battery, and a processor configured to measure physical characteristics associated with at least one of the supercapacitor battery and the EC battery; measure power provided from the EC battery during a period of time; determine an EC power consumption estimate based on the power provided from the EC battery and forecasted power consumption; determine a supercapacitor battery swap condition; and switch a power supply of the vehicle to the supercapacitor battery based on satisfying the supercapacitor battery swap condition.

### Energy Storage Unit (ESU):

The ESU is a device that can store and deliver charge. It may comprise one or more power packs, which may comprise supercapacitors. The energy storage module may also comprise batteries, hybrid systems, fuel cells, etc. Capacitance provided in the components of the ESU may be in the form of electrostatic capacitance, pseudocapacitance, electrolytic capacitance, electronic double-layer capacitance, and electrochemical capacitance, and a combination thereof, such as both electrostatic double-layer capacitance and electrochemical pseudocapacitance, as may occur in supercapacitors. The ESU may be associated with or comprise control hardware and software with suitable sensors, as needed, for an energy control system (ECS) to manage any of the following: temperature control, discharging of the ESU whether collectively or of any of its components, charging of the ESU whether collectively or of any of its components, maintenance, interaction with batteries, battery emulation, communication with other devices, including devices that are directly connected, adjacent, or remotely such as by wireless communication, etc. In some aspects, the ESU may be portable and provided in a casing containing at least some components of the energy control system (ECS) and features such as communication systems, a display interface, etc.

The term supercapacitor as used herein can also refer to an ultracapacitor, which is an electrical component capable of holding hundreds of times more electrical charge quantity than a standard capacitor. This characteristic makes ultracapacitors useful in devices that require relatively little current and low voltage. In some situations, an ultracapacitor can take the place of a rechargeable low-voltage electrochemical battery. In some examples, the terms supercapacitor or ultracapacitor as used herein can also refer to other types of capacitors.

### Energy Control System (ECS)

The energy control system (ECS) combines hardware and software that manages various aspects of the ESU, including its energy to the device. The ECS regulates the energy storage unit (ESU) to control discharging, charging, and other features as desired, such as temperature, safety, efficiency, etc. The ESU may be adapted to give the ECS individual control over each power pack or optionally over each supercapacitor or grouped supercapacitor unit to tap the available power of individual supercapacitors efficiently and to properly charge individual supercapacitors rather than merely providing a single level of charge for the ESU as a whole that may be too little or too much for individual supercapacitors or their power packs.

The ECS may comprise or be operatively associated with a processor, a memory comprising code for the controller, a database, and communication tools such as a bus or wireless capabilities for interacting with an interface or other elements or otherwise providing information, information requests, or commands. The ECS may interact with individual power packs or supercapacitors through a crosspoint switch or other matrix systems. Further, the ECS may obtain information from individual power packs or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack or supercapacitor.

The ECS may comprise one or more modules that the processor can execute or govern according to code stored in a memory such as a chip, a hard drive, a cloud-based source, or another computer-readable medium.

The ECS may therefore manage any or all of the following: temperature control, discharging of the ESU whether collectively or of any of its components, charging of the ESU whether collectively or of any of its components, maintenance, interaction with batteries, or battery emulation, and communication with other devices, including devices that are directly connected, adjacent, or remotely such as by wireless communication.

The ECS may comprise one or more energy source modules that govern specific energy storage devices, such as a supercapacitor module for governing supercapacitors and a lithium module for governing lithium batteries. An EC module for governing EC batteries and a hybrid module for governing the combined cooperative use of a supercapacitor and a battery. Each of the energy storage modules may comprise software encoding algorithms for control such as for discharge or charging or managing individual energy sources, and may comprise or be operationally associated with hardware for redistributing charge among the energy sources to improve the efficiency of the ESU, for monitoring charge via charge measurement systems such as circuits for determining the charge state of the respective energy sources, etc., and may comprise or be operationally associated with devices for receiving and sending information to and from the ECS or its other modules, etc. The energy source modules may also cooperate with a charging module responsible for guiding the charging of the overall ESU to ensure a properly balanced charge and a discharge module that guides the efficient discharging of the ESU during use which may also seek to provide proper balance in the discharging of the energy sources.

The ECS may further comprise a dynamic module for managing changing requirements in power supplied. In some aspects, the dynamic module comprises anticipatory algorithms that seek to predict upcoming changes in power demand and adjust the state of the ECS to be ready to handle the change more effectively. For example, in one case, the ECS may communicate with a GPS and terrain map for the route being taken by the electric vehicle and recognize that a steep hill will soon be encountered. The ECS may anticipate the need to increase torque and thus the delivered electrical power from the ESU and thus activate additional power packs if only some are in use or otherwise increase the draw from the power packs to handle the change in slope efficiently to achieve desired objectives such as maintaining speed, reducing the need to shift gears on a hill, or reducing the risk of stalling or other problems.

The ECS may also comprise a communication module and an associated configuration system to properly configure the ECS to communicate with the interface or other aspects of the vehicle and communicate with central systems or other vehicles when desired. In such cases, a fleet of vehicles may be effectively monitored and managed to improve energy efficiency and track the performance of vehicles and their ESUs, thereby providing information that may assist with maintenance protocols. Such communication may occur wirelessly or through the cloud via a network interface, share information with various central databases, or access information from databases to assist with the vehicle's operation and the optimization of the ESU, for which historical data may be available in a database.

Databases of use with the ECS include databases on the charge and discharge behavior of the energy sources in the ESU to optimize both charging and discharging in use based on known characteristics, databases of topographical and other information for a route to be taken by the electric vehicle or an operation to be performed by another device employing the ESU, wherein the database provides guidance on what power demands are to be expected in advance to support anticipatory power management wherein the status of energy sources. The available charge is prepared in time to deliver the needed power proactively. Charging databases may also help describe the characteristics of an external power source used to charge the ESU. The external charge characteristics can prepare for impedance matching or other measures needed to handle a new input source to charge the ESU. With that data, the external power can be received with reduced losses and reduced risk of damaging elements in the ESU by overcharge, an excessive ripple in the current, etc.

Beyond relying on static information in databases, in some aspects, the controller is adapted to perform machine learning (ML) and to learn from situations faced constantly. In related aspects, the processor and the associated software form a “smart” controller based on machine learning or artificial intelligence adapted to handle a wide range of input and a wide range of operational demands.

### ESU Hardware

Charming and Discharging Hardware

The charging and discharging hardware comprises the wiring, switches, charge detection circuits, current detection circuits, and other devices for proper control of charge applied to the power packs or the batteries or other energy storage units and temperature-control devices such as active cooling equipment and other safety devices. Active cooling devices (not shown) may include fans, circulating heat transfer fluids that pass through tubing or, in some cases, surround or immerse the power packs, thermoelectric cooling such as Peltier effect coolers, etc.

To charge and discharge an individual unit among the power packs to optimize the overall efficiency of the ESU, methods are needed to select one or more of many units from what may be a three-dimensional or two-dimensional array of connectors to the individual units. Any suitable methods and devices may be used for such operations, including crosspoint switches or other matrix switching tools. Crosspoint switches and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. SPST (Single-Pole Single-Throw) relays, for example, may be used. By applying a charge to individual supercapacitors within power packs or to individual power packs within the ESU, a charge can be applied directly to where it is needed, and a supercapacitor or power pack can be charged to an optimum level independently of other power packs or supercapacitors.

Configuration Hardware

The configuration hardware comprises the switches, wiring, and other devices to transform the electrical configuration of the power packs between series and parallel configurations, such as that a matrix of power packs may be configured to be in series, in parallel, or some combination thereof. For example, a 12×6 array of power packs may have four groups in series, with each group having 3×6 power packs in parallel. A command can modify the configuration from the configuration module, which then causes the configuration hardware to make the change at an appropriate time (e.g., when the device is not in use).

Sensors

The sensors may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs or batteries or other energy storage units or other characteristics of the ESU or the device as described more fully hereafter. The sensors may comprise sensors physically contained in or on the ESU or sensors mounted elsewhere, such as engine gauges in electronic communication with the ECS or its associated ESC.

Batteries and Other Energy Sources

The ESU may be capable of charging or supplementing the power provided from the batteries or other energy storage units, including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox flow batteries, supercapacitor batteries, and combinations or hybrids thereof.

Power Input/Output Interface

The ESU also comprises or is associated with a power input/output interface 152 that can receive charge from a device (or a plurality of devices in some cases) such as the grid or regenerative power sources in an electric vehicle (not shown) and can deliver charge to a device such as an electric vehicle (not shown). The power input/output interface may comprise one or more inverters, charge converters, or other circuits and devices to convert the current to the proper type (e.g., AC or DC) and voltage or amperage for either supplying power to or receiving power from the device it is connected to. Bidirectional DC-DC converters may also be applied.

The power input/output interface may be adapted to receive power from various power sources, such as via two-phase or three-phase power, DC power, etc. It may receive or provide power by wires, inductively, or other proper means. Converters, transformers, rectifiers, and the like may be employed as needed. The power received may be relatively steady from the grid or other sources at voltages such as 110V, 120V, 220V, 240V, etc., or from highly variable sources such as solar or wind power amperage or voltage vary. DC sources may be, by way of example, from 1V to 0V or higher, such as from 4V to 200V, 5V to 120V, 6V to 12V, 2V to 50V, 3V to 24V, or nominal voltages of about 4, 6, 12, 18, 24, 30, or 48 V. Similar ranges may apply to AC sources, but also including from 60V to 300V, from 90V to 250V, from 0V to 240 V, etc., operating at any proper frequency such as 50 Hz, 60 Hz, 120 Hz, etc.

Power received or delivered may be modulated, converted, smoothed, rectified, or transformed in any useful way to better meet the application's needs and the requirements of the device and the ESU. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient power transfer.

The power input/out interface may have a plurality of receptacles for receiving power and a plurality of outlets for providing power to one or more devices. AC outlets may include any known outlet standard in North America, various parts of Europe, China, Hong Kong, etc.

Energy Control System (ECS)

The energy storage unit (ESU) is governed or controlled by a novel energy control system (ECS) adapted to optimize at least one of charging, discharging, temperature management, safety, security, maintenance, and anticipatory power delivery. The ECS may communicate with a user interface such as a display interface to assist in control or monitoring of the ESU and also may comprise a processor and a memory. The ECS may interact with the ESU's hardware, such as the charging/discharging hardware and a temperature control system that provides data to the ECS and responds to directions from the ECS to manage the ESU.

The energy control system (ECS) may comprise a processor, a memory, one or more energy source modules, a charge/discharge module, a communication module, a configuration module, a dynamic module, an identifier module, a security module, a safety module, a maintenance module, and a performance module.

### ECS Components and Modules

Processor

The processor may comprise one or more microchips or other systems for executing electronic instructions and can provide instructions to regulate the charging and discharging hardware and, when applicable, the configuration hardware or other aspects of the ESU and other aspects of the ECS and its interactions with the device, the cloud, etc. In some cases, a plurality of processors may collaborate, including processors installed with the ESU and processors installed in a vehicle or other device.

Memory

The memory may comprise coding to operate one or more of the ECS and their interactions with other components. It may also comprise information such as databases on any aspect of the operation of the ECS, though additional databases are also available via the cloud. Such databases can include a charging database that describes the charging and discharging characteristics of a plurality or all energy sources (the power packs and the batteries or other energy storage units) to guide charging and discharging operations. Such data may also be included with energy-source-specific data provided by or accessed by the energy source modules.

The memory may be in one or more locations or components such as a memory chip, a hard drive, a cloud-based source, or another computer-readable medium, and may be in any application form such as flash memory, EPROM, EEPROM, PROM, MROM, etc., or combinations thereof and consolidated (centralized) or distributed forms. The memory may, in whole or part, be a read-only memory (ROM) or random-access memory (RAM), including static RAM (SRAM), dynamic RAM (DRAM), synchronous dynamic RAM (SDRAM), and magneto-resistive RAM (MRAM), etc.

Cloud Resources

The ECS may communicate with other entities via the cloud or other means. Such communication may involve information received from and provided to one or more databases and a message center. The message center can provide alerts to an administrator responsible for the ESU and the electric vehicle or another device. For example, an entity may own a fleet of electric vehicles using ESUs and may wish to receive notifications regarding usage, performance, maintenance issues, and so forth. The message center may also authenticate the ESU or verify its authorization for use in the electric vehicle or other devices (not shown) via interaction with the security module.

Energy Source Modules

The energy source modules may comprise specific modules designed to operate a specific energy source, such as a supercapacitor module, a lithium battery module, a lead-acid battery module, or other modules. Such modules may be associated with a database of performance characteristics (e.g., charge and discharge curves, safety restrictions regarding overcharge, temperature, etc.) that may provide information for use by the safety module and the charge/discharge module, which is used to optimize how each unit within the power packs or batteries or other energy storage units is used both in terms of charging and delivering charge. The charge/discharge module seeks to provide useful work from as much of the charge as possible in the individual power packs while ensuring that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

Charge/Discharge Module

The charge/discharge module is used to optimize each unit within the power packs, batteries, or other energy storage units to charge and deliver charge. The charge/discharge module seeks to provide useful work from as much of the charge as possible in the individual power packs while ensuring during charging that individual power packs are fully charged but not damaged by overcharging. The charge/discharge module can assist in directing the charging/discharging hardware, cooperating with the energy source modules. In one aspect, the ESU thus may provide real-time charging and discharging of the plurality of power packs while the electric vehicle is continuously accelerating and decelerating along a path.

The charge/discharge module may be configured to charge or discharge each of the plurality of power packs up to a threshold limit. The charge/discharge module may be coupled to the performance, energy storage, and identifier modules. It may communicate with the charging/discharging hardware of the ESU. For example, the threshold limit may be more than 90 percent capacity of each of the plurality of power packs in one aspect.

Dynamic Module

The dynamic module assists in coping with changes in operation, including acceleration, deceleration, stops, changes in slops (uphill or downhill), changes in traction or properties of the road or ground that affect traction and performance, etc., by optimizing the delivery of power or the charging that is taking place for individual power packs or batteries or other energy storage units. In addition to guiding the degree of power provided by or to individual power packs based on the current use of the device and the individual state of the power packs, in some aspects, the dynamic module provides anticipatory management of the ESU by proactively adjusting the charging or discharging states of the power packs such that added power is available as the need arises or slightly in advance (depending on time constants for the ESU and its components, anticipatory changes in status may only be needed for a few seconds (e.g., 5 seconds or less or 2 seconds or less) or perhaps only for 1 second or less such as for 0.5 seconds or less. Still, more extended preparatory changes may be needed in other cases, such as from 3 seconds to 10 seconds, to ensure that adequate power is available when needed but that power is not wasted by changing the power delivery state prematurely. This anticipatory control can involve increasing the current or voltage being delivered. Still, it can also involve increasing the cooling provided by the cooling hardware of the charging and discharging hardware in cooperation with the safety module and when suitable with the charge/discharge module.

The dynamic module may be communicatively coupled to the charge/discharge module. The dynamic module may be configured to determine the charging and discharging status of the plurality of power packs and batteries or other energy storage units in real-time. For example, in one aspect, the dynamic module may help govern bidirectional charge/discharge in real-time. The electric charge may flow from the ESU into the plurality of power packs and batteries or other energy storage units or vice versa.

Configuration Module

The ECS may comprise a configuration module configured to determine any change in the configuration of charged power packs from the charging module. For example, in one aspect, the configuration module may be provided to charge the configuration of the power packs, such as from series to parallel or vice versa. This may occur via communication with the charging/discharging hardware of the ESU.

Identifier Module

The identifier module, described in more detail hereafter, identifies the charging or discharging requirement for each power pack to assist in best meeting the power supply needs of the device. This process may require access to the database information about the individual power packs from the energy source modules (e.g., a supercapacitor module) and information about the current state of the individual power packs provided by the sensors and charge and current detections circuits associated with the charging and discharging hardware, cooperating with the charge/discharge module and, as needed, with the dynamic module and the safety module.

Safety Module

The sensors may communicate with the safety module to determine if the power packs and individual components show excessive local or system temperature signs that might harm the components. In such cases, the safety module interacts with the processor and other features (e.g., data stored in the databases of the cloud or memory pertaining to safe temperature characteristics for the ESU) to cause a change in operation such as decreasing the charging or discharging underway with the portions of the power packs or other units facing excessive temperature. The safety module may also regulate cooling systems that are part of the charging and discharging hardware to proactively increase the cooling of the power packs, batteries, or other energy storage units. Increasing the load on them does not lead to harmful temperature increases.

Thus, the safety module may also interact with the dynamic module in responding to forecasts of system demands in the near future for anticipatory control of the ESU for optimized power delivery. In the interaction with the dynamic module, the safety module may determine that an upcoming episode of high system demand such as imminent climbing of a hill may impose excessive demands on a power pack already operating at elevated temperature, and thus make a proactive recommendation to increase cooling on the at-risk power packs. Other sensors such as strain gauges, pressure gauges, chemical sensors, etc., may be provided to determine if any of the energy storage units in batteries or other energy storage units or the power packs are facing pressure buildup from outgassing, decomposition, corrosion, electrical shorts, unwanted chemical reactions such as an incipient runaway reaction, or other system difficulties. In such cases, the safety module may initiate precautionary or emergency procedures such as a shutdown, electrical isolation of the affected components, warnings to a system administrator via the communication module to the message center, and a request for maintenance to the maintenance module.

Maintenance Module

The maintenance module determines when the ESU requires maintenance, either per a predetermined scheduled or when needed due to apparent problems in performance, as may be flagged by the performance module, or in issues about safety as determined by the safety module based on data from sensors or the charging/discharging hardware, and in light of information from the energy sources modules. The maintenance module may cooperate with the communication module to provide relevant information to the display interface and the message center. An administrator or owner may initiate maintenance action in response to the message provided. The maintenance module may also initiate mitigating actions to be taken, such as cooperating with the charge/discharge module to decrease the demand on one or more of the power packs in need of maintenance and may also cooperate with the configuration module to reconfigure the power packs to reduce the demand in components that may be malfunctioning of near to malfunctioning to reduce harm and risk.

Performance Module

The performance module continually monitors the results obtained with individual power packs and the batteries or other energy storage units and stores information as needed in memory and the cloud databases or via messages to the message center. The monitoring is done using the sensors and the charging/discharging hardware, etc. The tracking of performance attributes of the respective energy sources can guide knowledge about the system's health, the capabilities of the components, etc., which can guide decisions about charging and discharging in cooperation with the charge/discharge module. The performance module compares actual performance, such as power density, charge density, time to charge, thermal behavior, etc., to specifications and can then cooperate with the maintenance module to help determine if maintenance or replacement is needed, and alert an administrator via the communication module with a message to the message center about apparent problems in product quality.

Security Module: Security and Anti-Counterfeiting Measures

The security module helps reduce the risk of counterfeit products or theft or misuse of legitimate products associated with the ESU, thus including one or more methods for authenticating the nature of the ESU and authorization to use it with the device in question. Methods of reducing the risk of theft or unauthorized use of an ESU or its respective power packs can include locks integrated with the casing of the ESU that mechanically secure the ESU in the electric vehicle or other devices, wherein a key, a unique fob, a biometric signal such as a fingerprint or voice recognition system, or other security-related credentials or may be required to enable removal of the ESU or even operation thereof.

In another aspect, the ESU comprises a unique identifier (not shown) that can be tracked, allowing a security system to verify that a given ESU is authorized for use with the device, such as an electric vehicle or other devices. For example, the casing of the ESU or one or more power packs therein may have a unique identifier attached, such as an RFID tag with a serial number (an active or passive tag), a holographic tag with unique characteristics equivalent to a serial number or password, nanoparticle markings that convey a unique signal, etc. One good security tool that may be adapted for the security of the ESU is a seemingly ordinary bar code or QR code with unique characteristics not visible to the human eye that cannot be readily copied that essentially allows ordinary QR codes and barcodes to become unique, individual codes by analysis of tiny imperfections in the printing to uniquely and robustly identify every individual product, even if it seems that the same code is printed on every one.

Yet another approach relies at least in part on the unique electronic signature of the ESU and one or more individual power packs or of one or more supercapacitor units therein. The principle will be described relative to an individual power pack but may be adapted to an individual supercapacitor or collectively to the ESU as a whole. When a power pack comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements, etc. An electronic signature of time effects (characteristic changes in time of voltage or current, for example, is a response to an applied load of some kind) may be explored for a specified scenario such as charging a 90% discharged power pack to a state of 50% charge, or examining the response to different applied voltages such as −3V to +4V. Voltammograms may be obtained showing, for example, the response of the power pack to different scan rates.

The security module recognizes that the details of supercapacitor response to a specific load or charge/discharge process may vary gradually over time, especially if the supercapacitor has been exposed to excess voltage or other mechanical or electrical stress can be adaptive and recognize and accept change within certain limits. Changes observed in the response characteristics can be used to update a security database or performance database for the ESU so that that future authentication operations will compare the measured behavior profile of the ESU's power pack in question with the updated profile for authentication purposes and for tracking of performance changes over time. Such information may also be shared with the maintenance module, including the maintenance database, which may trigger a request or requirement for service if there are indications of damage pointing to the need for repair or replacement. When a power pack or supercapacitor therein is replaced due to damage, the response profile of the power pack can then be updated in the security database. When such physical changes cause changes to the measured electronic characteristics that exceed a reasonable threshold, the authorization for the use of that ESU may be withdrawn pending further confirmation of authenticity or necessary maintenance.

In another aspect, each ESU and optionally each power pack of the ESU may be associated with a unique identifier registered in a blockchain system, and each “transaction” of the ESU such as each removal from a vehicle, maintenance operations, purchase or change in ownership, and installation into a vehicle or other device can be recorded and tracked. A code, RFID signal, or other identifiers may be read or scanned for each transaction, such that the blockchain record may then be updated. The blockchain record may comprise information about the authorization state of the product, such as information on what vehicle or vehicles or products the ESU is authorized for, or an identifier associated with the authorized user may be provided, which can be verified or authenticated when the ESU is installed in a new setting or when a transaction occurs. The authorization record may be updated at any time, including when a transaction occurs. The vendor may provide mechanisms to resolve disputes regarding authorization status or other questions.

In some aspects, such as in military or government operation, the ESU may comprise an internal “kill switch” or other inactivation devices that authorities can remotely activate in the event of a crime, unauthorized use, or violation of a contract. Alternatively, an electric vehicle or other devices may be adapted to reject the installation of an ESU that is not authorized for use in the vehicle or device.

Communication Module

The communication module can govern communications between the ECS and the outside world, including communications through the cloud, such as making queries and receiving data from various external databases or sending messages to a message center where they may be processed and archived by an administrator, a device owner, the device user, the ESU owner, or automated systems. In some aspects, the communication module may also oversee communication between modules or between the ESU and the ECS and work in cooperation with various modules to direct information to and from the display interface. Communications within a vehicle or between the ECS or ESU and the device may involve a DC bus or other means such as separate wiring. Any suitable protocol may be used, including UART, LIN (or DC-LIN), CAN, SPI, I2C (including Intel's SMBus), and DMX (e.g., DMX512). In general, communications from the ECS or ESU with a device may be over a DC bus or, if needed, over an AC/DC bus, or by separately wired pathways if desired, or wireless.

Communication to the cloud may occur via the communication module and involve wired or wireless connections. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

Electrostatic Module

Assessment of charge in an energy storage unit can be conducted based on measurements made with the charging/discharging hardware in communication with specific modules of the ECS. In general, an electrostatic module can manage the measurement of charge and processing of the data.

The electrostatic module may be configured to identify the power pack type and the capacity of each power pack connected to the modular multi-type power pack energy storage unit. Further, the electrostatic module may be configured to retrieve information related to the type of power packs from the charging database. The electrostatic module may determine the capacity of each power pack to be charged. It may be configured to determine the capacity of each power pack when connected to the modular multi-type power pack ESU.

The electrostatic module may be configured to determine if each power pack charged below the threshold limit. For example, in one aspect, the electrostatic module may check whether each of the plurality of power packs may have a capacity below the threshold limit. The electrostatic module may also be configured to send data related to power packs to the ECS.

### Various Databases

The ECS may access various databases via an interface to the cloud and store retrieved information in the memory to guide the various modules.

Further, the memory may comprise a charging database or information from such a database obtained from the databases or the cloud. In one aspect, the charging database may be configured to store information related to various power packs used while charging and discharging from the ESU. In one aspect, the charging database may be configured to store information related to the power cycle of each of the plurality of power packs, the maximum and minimum charge for different types of power packs, and the state of charge (SoC) profile of each of the plurality of power packs.

The charging database may be configured to store information related to managing the plurality of power packs, such as the type of power pack to be charged, safety specifications, recent performance data, bidirectional charging requirements, or history of each of the plurality of power packs, etc. In another aspect, the stored information may also include, but is not limited to, the capacity of each of the plurality of power packs, amount of charge required for one trip of the electric vehicle along the path, such as golf course, etc., charging required for a supercapacitor unit, etc. In another aspect, the charging database may provide a detailed research report for the electric vehicle's average electric charge consumption over a path. In one aspect, the charging database may be configured to store information related to the consumption of the electric charge per unit per kilometer drive of the electric vehicle from the plurality of power packs. For example, such information may indicate that a golf cart is equipped with five supercapacitor-driven power packs each at 90% charge, with each power packable to supply a specified amount of ampere-hours (Ah) of electric charge resulting in an ability to drive under normal conditions at top speed for, say, 80 kilometers. The information may also indicate that a solar cell installed on the roof of the golf cart would, under current partly clouded conditions, still provide enough additional charge over the planned period of use to extend the capacity of the ESU by another 40 kilometers for one passenger.

The performance module may use the charging database to read data and store new data on the individual energy storage units such as the power packs.

### Power Pack

A power pack is a unit that can store and deliver charge within an energy storage unit and comprises one or more supercapacitors such as supercapacitors in series and parallel. It may further comprise or cooperate with temperature sensors, charge and current sensors (circuits or other devices), connectors, switches such as crosspoint switches, safety devices, and control systems such as charge and discharge control systems. In various aspects described herein, the power pack may comprise a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack may have a functional temperature range from −70° C. to +° C., such as from −50° C. to ° C. or from −40° C. to 80° C. The voltage provided by the power pack may be any practical value such as 3V or more significant, such as from 3V to 240 V, 4V to 120 V, etc.

By way of example, a power pack may comprise one or more units, each comprising at least one supercapacitor having a nominal voltage from 2 to 12 V, such as from 3 to 6 V, including supercapacitors rated at about 3, 3.5, 4, 4.2, 4.5, and 5 V. For example, in discharge testing, a power pack was provided and tested with 14 capacitors in series and five series in parallel charged with 21,000 F at 4.2 V and had 68-75 Wh. Power packs may be packaged in protective casings that can easily be removed from an ESU and replaced. They may also comprise connectors for charging and discharging. Power packs may be provided with generally rectilinear casings, or they may have cylindrical or other useful shapes.

### Supercapacitor Information

Supercapacitors

A supercapacitor may have two electrode layers separated by an electrode separator wherein each electrode layer is electrically connected to a current collector supported upon an inert substrate layer; further comprising an electrolyte-impervious layer disposed between each electrode layer and each conducting layer to protect the conducting layer, and a liquid electrolyte disposed within the area occupied by the active electrode layers and the electrode separator. To inhibit electrolyte flow, the liquid electrolyte may be an ionic liquid electrolyte gelled by a silica gellant or other gellant.

The supercapacitor may comprise an electrode plate, an isolation film, a pole, and a shell. The electrode plate comprises a current collector, and a coating is disposed of on the current collector. The coating may comprise an active material that may include carbon nanomaterial such as graphene or carbon nanotubes, including nitrogen-doped graphene, a carbon nitride, carbon materials doped with a sulfur compound such as thiophene or poly 3-hexylthiophene, etc., or graphene on which is deposited nanoparticles of metal oxide such as manganese dioxide. The coating may further comprise a conductive polymer such as one or more polyaniline, polythiophene, and polypyrrole. Such polymers may be doped with various substances such as boron (especially in the case of polyaniline).

Electrodes in supercapacitors may have thin coatings in electrical communication with a current collector, to provide high electrode surface area for high performance, electrodes may comprise porous material with a high specific surface area such as graphene, graphene oxide, or various derivatives of graphene, carbon nanotubes or other carbon nanomaterials including activated carbon, nitrogen-doped graphene or another doped graphene, graphite, carbon fiber-cloth, carbide-derived carbon, carbon aerogel. They may comprise various metal oxides such as oxides of manganese, etc. All such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors about charge state, temperature, and other performance and safety aspects. An actuation mechanism may be integrated to prevent undesired discharge.

The voltage of an individual supercapacitor may be greater than 2 V, such as from 2.5 V to 5 V, 2.7 V to 8 V, 2.5 V to 4.5 V, etc.

Supercapacitors can be divided into units of smaller supercapacitors. In one embodiment, a “constant voltage unit” of five units can be joined together in parallel to maintain the voltage but supply five times more current. In another embodiment, a “constant current unity” can include five units joined together in series to multiply the unit voltage by five times but maintain the current. In another embodiment, supercapacitors can provide hybrid “constant voltage units” and “constant current units.” In yet another embodiment, supercapacitors units can be connected in any number of combinations to end up with a supercapacitor of optimum design. In another embodiment, each supercapacitor unit can comprise various subunits or pouches. Supercapacitor subunits can be combined using constant current, voltage, or any combination. Supercapacitor units or sub-units can comprise size or form factors in yet another embodiment. In yet another embodiment, each subunit and unit can be uniquely addressed to turn on or off the supercapacitor unit or sub-unit on or off. This is achieved with any variety of crossbar switches. A crossbar switch is an assembly of individual switches between inputs and a set of outputs. The switches are arranged in a matrix. If the crossbar switch has M inputs and N outputs, then a crossbar has a matrix with M×N cross-points or places where the connections cross. At each crosspoint is a switch; when closed, it connects one of the inputs to one of the outputs. A given crossbar is a single layer, non-blocking switch. A non-blocking switch means that other concurrent connections do not prevent connecting other inputs to other outputs. Collections of crossbars can be used to implement multiple layers and blocking switches. A crossbar switching system is also called a coordinate switching system. In this way, a crossbar switch can select any combinations of pouches or subunits and units to obtain any combination. The crossbar switches can be used to test units or subunits and optimize supercapacitor performance.

### Powered Devices and Electric Vehicles, Etc.

Powered devices powered by the ESU can include electric vehicles and other transportation devices of all kinds, such as those for land, water, or air, whether adapted to operate without passengers or with one or more passengers. Electric vehicles may include automobiles, trucks, vans, forklifts, carts such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like, etc. The electric vehicle generally comprises one or more motors connected to the ESU and an energy control system (ECS) that controls the power delivered from the ESU and may comprise a user interface that provides information and control regarding the delivery of power from the ESU as well as information regarding performance, remaining charge, safety, maintenance, security, etc. Not all transportation devices require non-stationary motors. An elevator, for example, may have a substantially stationary motor while the cabin moves between the level of a structure. Other transport systems with mobile cabins, seats, or walkways may be driven by stationary motors driving cables, chains, gears, bands, etc.

Apart from electric vehicles, there are many other devices that the ESU may power in cooperation with the ESC. Such other devices can include generators, which in turn can power an endless list of electric devices in households and industry. ESUs of various sizes and shapes can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the powered device is the grid, and in such versions, the ESU may comprise an inverter to turn DC into AC suitable for the grid.

In some aspects, a plurality of devices such as electric vehicles may be networked together via a cloud-based network, wherein the devices share information among themselves and with a central message center such that an administrator can assist in managing the allocation of resources, oversee maintenance, evaluate the performance of vehicles and ESUs, upgrade software or firmware associated with the ESC to enhance performance for the particular needs of individual users or a collective group, adjust operational settings to better cope with anticipated changes in weather, traffic conditions, etc., or otherwise optimize performance.

Implementation in Hybrid Vehicles

When installed in electric vehicles, the ESU may comprise both power packs and one or more lead-acid batteries or other batteries. The ESU may power both the motor and the onboard power supply system. The display interface of the associated ESC may comprise a graphical user interface such as the vehicle's control panel (e.g., a touch panel). The display interface may also comprise audio information and verbal input from a user.

Motors

The ESU may power any electric motor. The major classes of electric motors are: 1) DC motors, such as series, shunt, compound wound, separately excited (wherein the connection of stator and rotor is made using a different power supply for each), brushless, and PMDC (permanent magnet DC) motors, 2) AC motors such as synchronous, asynchronous, and induction motors (sometimes also called asynchronous motors), and 3) special purpose motors such as servo, stepper, linear induction, hysteresis, universal (a series-wound electric motor that can operate on AC and DC power), and reluctance motors.

Display Interface

The display interface of the ESC may be displayed on or in the device, such as on a touch screen or other display in a vehicle or on the device, or it may be displayed by a separate device such as the user's phone. The display interface may comprise or be part of a graphic user interface such as the vehicle's control panel (e.g., a touch panel). The display interface may also comprise audio information and verbal input from a user. It may also be displayed on the ESU itself or a surface connected to or communicated with the ESU. In one version, the display interface may include but is not limited to a video monitoring display, a smartphone, a tablet, and the like, each capable of displaying a variety of parameters and interactive controls. Still, the display could also be as simple as one or more lights indicating charging or discharging status and optionally one or more digital or analog indicators showing remaining useful lifetime, % power remaining, voltage, etc.

Further, the display interface may be any state-of-the-art display means without departing from the scope of the disclosure. In some aspects, the display interface provides graphical information on charge status, including one or more fractions of charge remaining or consumed, remaining useful life of the ESU or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU for shipping, discharge the ESU, increase active cooling, only apply low power, etc.); planned conditions for use (e.g., outdoors, high-humidity, in the rain, underwater, indoors, etc.). Selections may be made through menus and buttons on a visual display, through audio “display” of information responsive to verbal commands, or through text commands or displays transmitted to a phone or computer, including text messages or visual display via an app or web page.

Thus, the ESU may comprise a display interface coupled to the processor to continuously display the status of charging and discharging the plurality of power packs.

### Solar Power and Alternate Energy Systems

Solar panels produce electrical power through the photovoltaic effect, converting sunlight into DC electricity. This DC electricity may be fed to a battery via a solar regulator to ensure proper charging and prevent damage to the battery. While DC devices can be powered directly from the battery or the regulator, AC devices require an inverter to convert the DC electricity to suitable AC at, for example, 110V, 120V, 220V, 240V, etc.

Solar panels may be wired in series or in parallel to increase voltage or current, respectively. The rated terminal voltage of a 12 Volt solar panel may be around 17 Volts, but the regulator may reduce the voltage to a lower level required for battery charging.

Solar Regulators

Solar regulators (also called charge controllers) regulate current from the solar panels to prevent battery overcharging, reducing or stopping current as needed. They may also include a Low Voltage Disconnect feature to switch off the supply to the load when the battery voltage falls below the cut-off voltage and prevent the battery from sending charge back to the solar panel in the dark.

Regulators may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current-voltage like a conventional step-down DC-DC converter but adding the “smart” aspect of monitoring of the variable maximum power point of the panel to adjust the input voltage of the DC-DC converter to deliver optimum power.

Inverters

Inverters are devices that convert DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage but are more complex and costly than on-grid systems, requiring additional equipment. An inverter/charger that manages both grid connection and the charging or discharging of batteries may be an interactive or multi-mode inverter. A variation of such inverters is known as the all-in-one hybrid inverter.

Output from inverters may be in the form of a pure sine wave or a modified sine wave, or a square wave. The less expensive modified sine wave output may damage some electronic equipment. Multiple solar panels are connected to a single inverter in a “string inverter” setup in many conventional systems. This can limit system efficiency, for when one solar panel is shaded and has reduced power, the overall current provided to the inverter is likewise reduced. String solar inverters are provided in single-phase and three-phase versions.

Microinverters are miniature forms of inverters that can be installed on the back of individual solar panels, providing the option for AC power to be created directly by the panel. In some examples solar panels can include microinverters. Unfortunately, microinverters limit battery charging efficiency, for the AC power from the panels must be converted back to DC power for battery charging. They also add high costs to the panels. The additional equipment on the panel may also increase maintenance problems and possibly the risk of lightning strikes. Microinverters generally use maximum power point tracking (MPPT) to optimize power harvesting from the panel or module connected to it.

The on-grid string solar inverters and microinverters, collectively called solar inverters, provide AC power fed to the grid or directly to a home or office. Alternatively, off-grid inverters (or “battery inverters”) or hybrid inverters can charge batteries. Hybrid inverters can charge batteries with DC and provide AC for the grid or local devices, combining a solar inverter and battery inverter/charger into a single unit.

Solar power systems may employ “deep cycle solar batteries” designed for discharge over a long time (e.g., several days). Such batteries may be at risk of permanent damage if highly discharged, such as below 30% capacity. They also may suffer the drawback of delivering less total charge at a high load than at a low load due to overheating problems at elevated discharge rates.

### General Language:

All patents and applications cited must be understood as being incorporated by reference to their compatible degree.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to 200° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

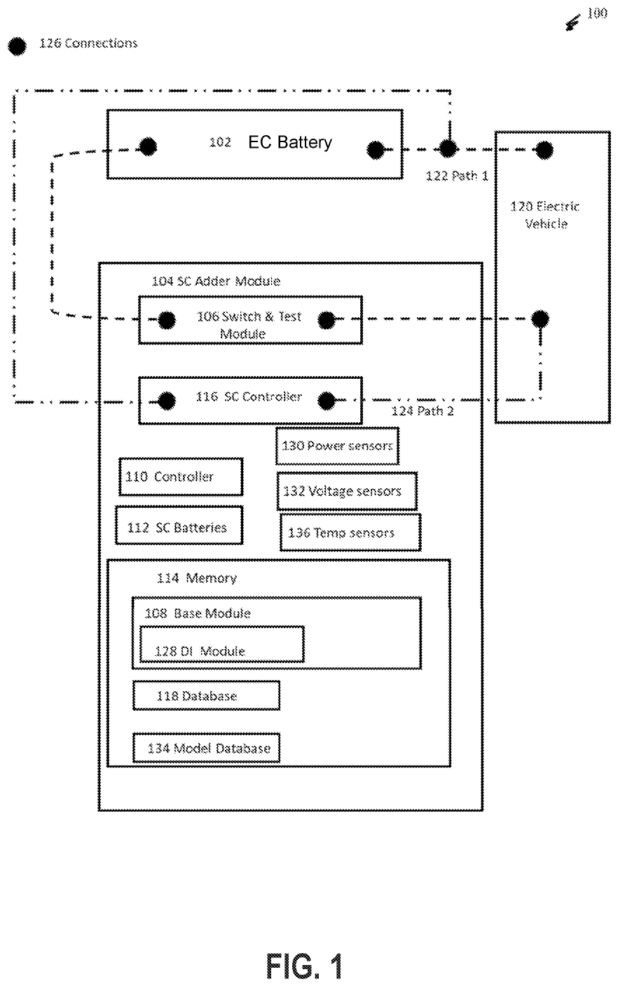

FIG. 1. is a system for a supercapacitor and EC Battery Hybrid battery with a dynamic impedance (DI) matching capability. This system 100 comprises an electrochemical (EC) battery, such as a lead-acid battery or a lithium ion battery, that is integrated with the SC adder module 104. Further, the SC adder module 104 is a self-contained unit. SC adder module 104 integrates supercapacitor batteries 112. The supercapacitor (SC) battery 112 is integrated into an SC adder module 104 and is isolated from the EC battery 102. In some aspects, the SC battery 112 includes a higher capacity than electrochemical batteries as they deliver charges at a much smaller weight and size. The SC adder module 104 comprises a plurality of SC batteries 112 and contains a control system to connect to electric vehicle 120. The SC adder module 104 uses the SC controller 116 to switch a power source of the electric vehicles to and from SC batteries 112 and EC battery 102 as needed. The SC adder module contains a memory 114 and a base module 108 that controls the DI Module 128. In some cases, the SC adder module 104 executes and controls a plurality of temperature sensors 136, voltage sensors 132, and power sensors 130. The SC adder module 104 includes a database 118 that stores and uses all relevant information to the DI Module 128. The SC adder module 104 includes a controller 110 that executes instructions from memory 114. The SC adder module 104 also contains a model database 134. Further, switch and test module 106 allows amperage measurement in path 1 to see how much amperage is drawn through EC Battery 102 and electric vehicles 120. A switch and test module 106 can also be instructed to disconnect or connect EC battery 102 to electric vehicle 120 using a digitally controlled high-powered relay (not shown). In some aspects, the switch and test module 106 can also operate in milliseconds to ensure the smooth operation of electric vehicle 120.

In some aspects, the base module 108 executes its normal functions of managing the electric vehicle (not shown), such as speed optimization, power management, safety monitoring, etc. The base module 108 provides a waiting period. In one embodiment, the waiting period is a period that is likely not to affect a significant discharge of the EC battery, e.g., <5 minutes. The base module 108 switches on Path 1 122 using the switch and a test module 106 to disconnect path 2 124 is off using the SC controller 116. The base module 108 may be configured to execute the DI Module 128. In some aspects, the base module 108 determines if the SC batteries have been recharged; if yes, Base Module 108 loops back. If not, base module 108 keeps path 1 122 connected, and allows the EC batteries 102 to be connected to electric vehicle 120 until the SC batteries 112 have been recharged. Further, the controller 110 is a processor to execute commands in memory 114 from the base module 108, allows read and write operations to the database 118, and allows instruction to turn on and off the SC controller 116. The controller 110 also allows current measurements from path 1 122 to be collected and stored (in real-time) in database 118. The controller 110 also controls the switching of the high-powered switching relay in path 1 122 while base module 108 executes. In some aspects, the SC Batteries 112 are any type or group of supercapacitor batteries designed to have enough capacity to run devices connected to electric vehicle 120. The memory 114 is configured to store the Base Module 108 and its sub-modules and the database 118. Further, the SC controller 116 polls the base module 108 for various operations. For example, the SC Controller 116 determines if the base module 108 is configured to connect the SC batteries 112 to electric vehicle 120 by path 1 with a high-powered switching relay (not shown). The SC controller 116 is invoked by the base module 108 to switch between the EC batter 102 and the SC Batteries 112. The database 118 allows reading and writing data from the base module 108 and sub-modules and data associated with the switch and test module 116 and the SC controller 116. The database 118 also stores the recommended max charging energy or amperage for the SC batteries 112, as well as all needed wait times and charge times used by the base module 108. The base module 108 is configured to provide instructions to power sensors 130, voltage sensors 132, temperature sensors 136 for various measurements of the electric vehicle 120. In one aspect, the electric vehicle 120 is a personal transport vehicle (e.g., cars, golf carts, RV's, etc.) or other commercial vehicle (delivery truck, construction equipment, farm equipment, etc.).

In some aspects, the path 1 122 selectively connects the electric vehicle 120 to the EC battery 102, which is interrupted by the SC adder module 104. In some aspects, the path 2 124 selectively connects the electric vehicle 120 and SC controller 116, allowing the flow of charge from the SC batteries 112 into electric vehicle 120. The connection 126 shows terminals (such as battery terminals) to connect SC Adder Module 104 into the system 100. The connections of EC battery 102, switch and test module 106, and SC controller 116 are unavailable to the user element 126. Further, the DI Module 128 executes based on instructions from the base module 108. In some cases, the EC battery 102 may be connected via the path 1 122 to electric vehicle 120 while the path 2 124 is off, disconnecting the SC batteries 112. In some aspects, the DI Module 128 includes a model database 134 that is generated by impedance modeling and actual power data versus time data for comparable EC batteries for average trip use compared to an SC battery 112. The DI Module 128 may use the model database 134 to determine voltage profile data using a dynamic impedance model of the supercapacitor that models the voltage versus time data for comparable SC batteries. The DI Module 128 uses the model database 134 to determine a voltage profile data using a dynamic impedance model of voltage impacted by temperature versus time data for comparable SC batteries. In some aspects, the DI Module 128 measures temperature, using temperature sensors 136 and stores various temperatures in database 118. The DI Module 128 measures power using power sensors 130 of EC batteries 102 over time intervals and stores the measured power data in database 118. The DI Module 128 is also configured to execute and update a simulation model (not shown) using the current temperature data in the database 118. The model database includes dynamic power profiles of the SC battery 112 over various temperatures and their related simulated voltage profile of supercapacitors. The DI Module 128 determines if the EC battery power consumption profile relates to a supercapacitor voltage threshold of the model. For example, when the predicted supercapacitor voltage is above a threshold, it is safe to connect SC batteries 112 based on the SC batteries 112 having lower power dissipation in this case, and turn off path 1 122 using the switch and test module. The DI Module 128 measures a voltage of SC batteries 112 using voltage sensors 132 and stores the voltage data in the database 118. In some cases, the DI Module 128 determines if the voltage of the SC battery 112 is below a threshold (for example >20% of starting voltage), the EC battery 102 is connected by path 1 122 to electric vehicle 120 using the switch and test module 106. Further, the power sensors may be configured measure voltage and current, and then these measurements are multiplied to yield a power measurement. In some aspects, the power sensor is connected to switch and test module 106 when the EC batteries 102 are connected to electric vehicle 120. The power data may be stored in the database 118. In some aspects, the voltage sensors 132 measure the voltage of SC batteries 112, and are connected to supercapacitor batteries 112 thru SC controller 116. The model database 134 stores the dynamic impedance model of SC battery power, a model of the EC battery, and determine supercapacitors power consumption based on a predicted use. The model database 134 includes data and models across different temperatures and operating parameters. The impedance of a supercapacitor is modeled using a dynamic impedance that changes based on physical characteristics of the environment. The temperature sensors 136 measure the operating temperature of the SC batteries 112 in real-time and store the temperature data in database 118 to improve efficiency of a heterogenous battery system including, for example, an EC battery and a SC battery.

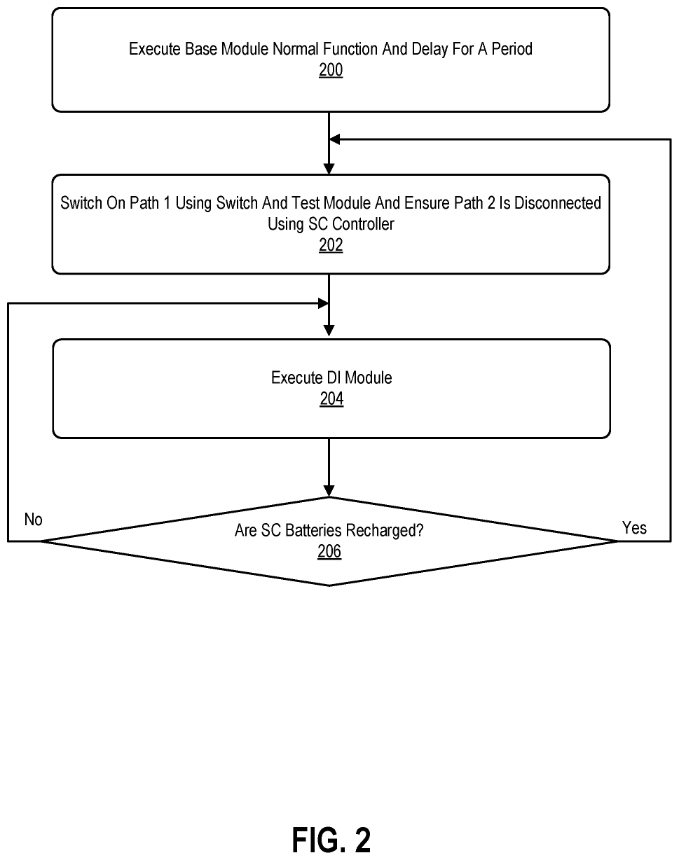

Functioning of the Base Module will now be explained with reference to FIG. 2. One skilled in the art will appreciate that, for this and other processes and methods disclosed herein, the functions performed in the processes and methods may be implemented in a different order. Furthermore, the outlined steps and operations are only provided as examples, and some of the steps and operations may be optional, combined into fewer steps and operations, or expanded into additional steps and operations without detracting from the essence of the disclosed embodiments.

FIG. 2. is a flowchart of a process executed by the base module 108 in accordance with some aspects of the disclosure. The process begins with Base Module 108 reading the database 118 for OBC data, and if an OBC error is found, the process stops execution of the base module 108 at step 200. If the error is not identified, the base module 108 executes its normal functions and then delays for a delay period. In one example, the base module 108 may perform other functions that relate to SC battery 112 optimization functions, such as speed optimization, detecting temperature changes, performing safety checks, etc. (all not shown). The wait time could be a simple wait period of 5 minutes or calculated by using ML by searching for patterns over time, at step 202. Base Module, 108 switched on Path 1 122, using SC Controller 116 to connect SC battery 112 thru Charger Test HDWR to Electric Vehicle 120, at step 204. Base Module 108 polls and measures if SC battery 112 is being charged (charger is attached to SC Controller 116 connections (“A” and “B”), if the battery is being charged, execute module 128, else loop back to step 202, at step 206.

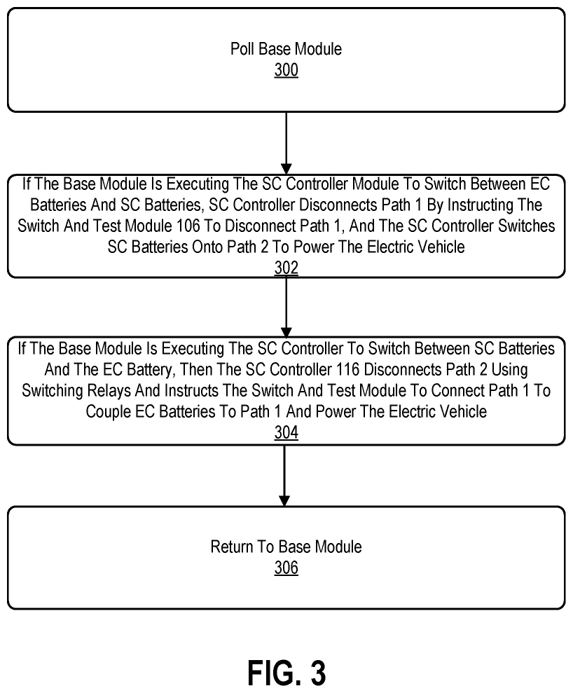

Functioning of the SC Controller will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3, shows the SC Controller 116 operation. The process begins with SC Controller 116 polls Base Module 108, at step 300. SC Controller 116 determines if Base Module 108 executes SC Controller 116 to switch between EC Batteries 102 and SC Batteries 112, then SC Controller 116 disconnects path 1 by instructing the switch and test module 106 to disconnect path 1 (not shown this is done with a high powered switching relay) and SC Controller 116 switches SC Batteries 112 onto path 2, using high powered switching relays (not shown) so that Electric Vehicle 120 has power, at step 302. SC Controller 116 determines if Base Module 108 executes SC Controller 116 to switch between SC Batteries 112 and EC Batteries 102. SC Controller 116 disconnects path two using high-powered switching relays (not shown) and then instructs the switch and test module 106 to connect path 1 122. This allows EC Battery 102 onto path 1 so that Electric Vehicle 120 has power at step 304. SC Controller 116 then returns control to Base Module 108 at step 306.

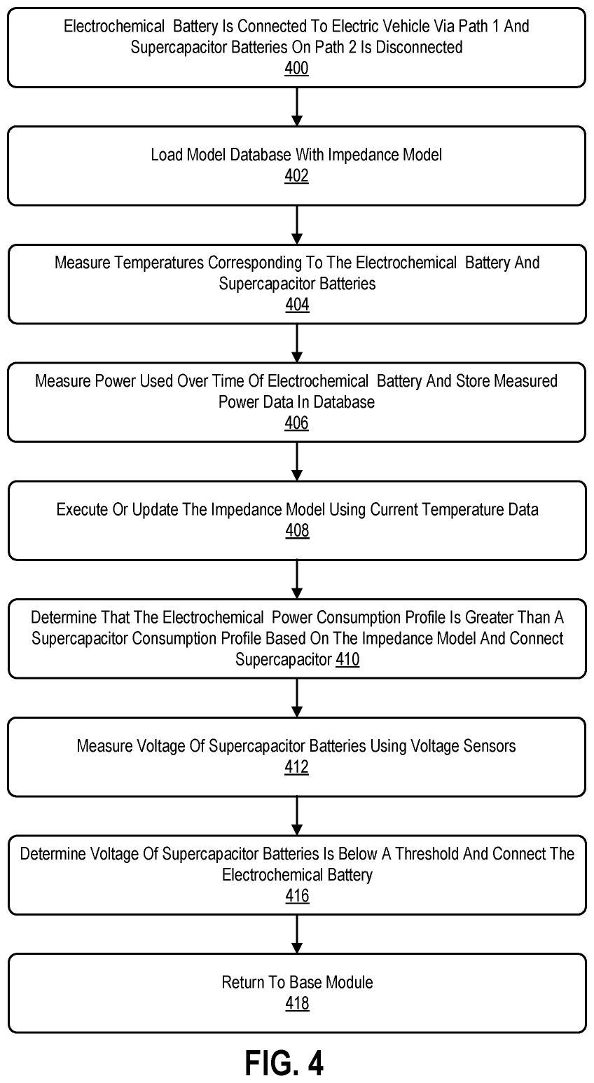

Functioning of the dynamic impedance (DI) module will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 4. illustrates a flowchart of a DI Module in accordance with some aspects of the disclosure. The process begins with DI Module 128 executing from base module 108. At block 400, the DC battery 102 loop is connected to the vehicle on path 1 122 and path 2 124 is off and the SC batteries 112 are disconnected. In some aspects, the DI Module 128 includes model database 134 that is generated by impedance modeling that can be used to identify parasitics of the battery and determine an ideal power source based on various conditions. The model database 134 includes actual power data versus time data for comparable EC batteries for average trip use and SC batteries for average trip use. In one aspect, the model database 134 is configured to simulate a voltage profile data using a dynamic impedance model of voltage versus time data for similar SC batteries for comparison to SC batteries 112. In additional aspects, the DI Module 128 can use the model database 134 to simulate voltage profile data using a dynamic impedance model of a voltage impacted by temperature versus time data for comparable SC batteries compared to SC batteries 112.

At block 404, the DI Module 128 may be configured to measure temperature using temperature sensors 136 and store temperature data in database 118. After measuring the temperature, at block 406, the DI Module 128 is configured to cause power sensors 130 to measure power (using power sensors 130) of the EC batteries 102, over time intervals and stores data in database 118. At block 408, the DI Module 128 executes and updates the simulation model (not shown) using the current temperature data in the database 118. In some cases, the model database includes dynamic power profiles of energy by temperatures and their related simulated voltage profile of supercapacitors. In some aspects, the simulation model may be a machine learning (ML) model that is trained to identify trends and patterns that are difficult to perceive based on the volume of data. At block 410, the DI Module 128 determines if the EC battery 102 power consumption profile is less than to a supercapacitor voltage threshold of the model. In some aspects, when the predicted supercapacitor voltage is above a threshold, it is safe to switch in SC batteries 112 due to a lower power disspation and disconnect the EC battery 102 on the path 1 122 using the switch and test module 106.

At block 412, the DI Module 128 measures a voltage of the SC batteries 112 using voltage sensors 132 and stores the voltage into the database 118. The DI module 128 determines if an EC battery swap condition (e.g., a voltage used falls below a threshold, for example >20% of starting voltage). If the EC battery swap condition is satisfied, the path 2 124 is disconnected to disconnect the SC battery 112 and path 1 122 is connected using the switch and test module 106 to connect the EC batteries 102 to connect to Electric Vehicle 120. If the EC battery swap condition is not satisfied, the SC battery remains connected. At block 418, the DI Module 128 returns back to base module 108.

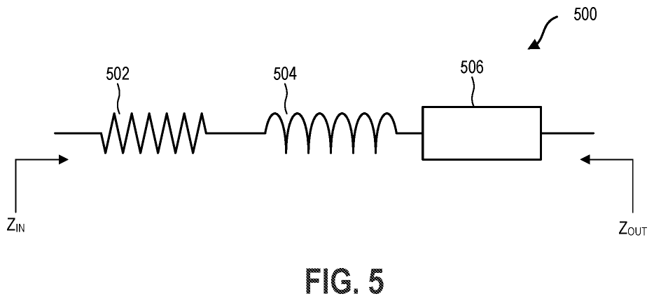

FIG. 5 is a block diagram of an equivalent circuit model 500 of a supercapacitor in accordance with some aspects of the disclosure. In one aspect, the supercapacitor can be modeled by a resistor 502 in series with an inductor 504 and a complex impedance 506. In some aspects, the supercapacitor comprises a plurality of supercapacitors that are in parallel and are selectively activated to provide power. In this case, the impedance of the supercapacitor is dynamic and dependent on the number of supercapacitors that are connected to the electric vehicle 120. In this case, the resistor 502 may be affected based on the number of supercapacitors that are connected to the electric vehicle 120.

In some aspects, supercapacitors can be modeled a dynamic impedance based on a dynamic current profile. While the resistor 502 provides a simple impedance and the inductor 504 represents a charge that is accumulated throughout different parts of supercapacitor, voltage and temperature of supercapacitors change significantly and a measured impedance across current, voltage, and temperature can vary significantly. The complex impedance 506 can be created based on the operating variations and the porous structure of electrodes within the supercapacitor. In some aspects, because the porous structure of the electrodes, the real part of the impedance increases with decreasing frequency and the capacitance increases with increasing frequency.

In some aspects, a model of the impedance can be measured and modeled prior to deployment, and the model can be trained using machine learning or federated learning techniques. As more data related to the supercapacitor becomes available based on usage, the model of the impedance can be improved.

The model of the impedance affects decisions made by various aspects of the electric vehicle. For example, the resistance of the resistor 502 in the equivalent circuit model 500 causes a power loss and increases an amount of thermal noise that needs to be dissipated. As temperature of the supercapacitor or temperature of conductors connected to the supercapacitor increase, the thermal noise will increase and continue to reduce power efficiency. In addition, the parasitics such as the inductor 504 and the complex impedance 506, may cause issues in various operations, such as switching between different operating voltages or other transient changes. For example, if the supercapacitor frequently shifts voltage, the voltage shift can increase a frequency component that may cause various electromagnetic effects to occur. The input impedance ZIN and the output impedance ZOUT may also differ based on the non-linear aspects of the complex impedance 506

In some aspects, the external ambient environment and the drive profile also affect the thermal dissipation and the operation of the supercapacitor. For instance, frequent stops can increase power consumption due to increased acceleration events, which require more power draw than cruising. Further, cruising increases the ambient cooling options. The temperature of the supercapacitor can therefore be modeled in multiple dimensions including temperature, power dissipation, and drive profile. Additional factors can include supercapacitor life (e.g., based on charge/discharge cycles), humidity, ambient temperature, and so forth.

In some aspects, the dynamic impedance model can be included a battery swap condition that is based at least on the physical characteristics (e.g., temperature, ambient cooling). In some aspects, the battery swap condition can be included an EC battery swap condition for coupling the EC battery to the electric vehicle, or a supercapacitor battery swap condition for coupling the supercapacitor to the electric vehicle. In some aspects, the conditions are selected to reduce power dissipation based on dynamic conditions, such as drive profile, forecasted temperature of the battery, and so forth. In this case, battery swap condition can be an inflection point or condition (e.g., a line when there are multiple variables) at which the power consumption can be improved based on decoupling one battery and coupling the other battery.

In some aspects, the drive profile includes parameters relevant to the trip, such as average speed, mean time and standard deviation of time between acceleration and deceleration events (e.g., from a minimum speed to a cruising speed, etc.). For example, in some aspects, the power consumption is higher during acceleration events and more thermal noise of the conductors within the electric vehicle can be created with lower voltage circuits due to the larger power draw. The additional current required for higher power can add a significant amount of thermal noise (or energy that is converted into heat) and increase the loss. In this example, it may be beneficial to power the electric vehicle during acceleration events with the EC battery for acceleration, but switch to the SC battery when power consumption falls after a significant amount of acceleration.

Illustrative aspects of the disclosure include updating the impedance model based on data recorded during operation of the vehicle. In some cases, the data recorded can identify trends of the SC battery or the EC battery to ensure that the impedance model is accurately reflected based on use. In some aspects, the charge/discharge cycles can affect the materials and thereby affect the various parameters of the equivalent circuit model 500. For example, the complex impedance 506 may change based on the lifecycles of the individual supercapacitors that are combined to form the supercapacitor, which changes the parameters associated with the complex impedance 506.

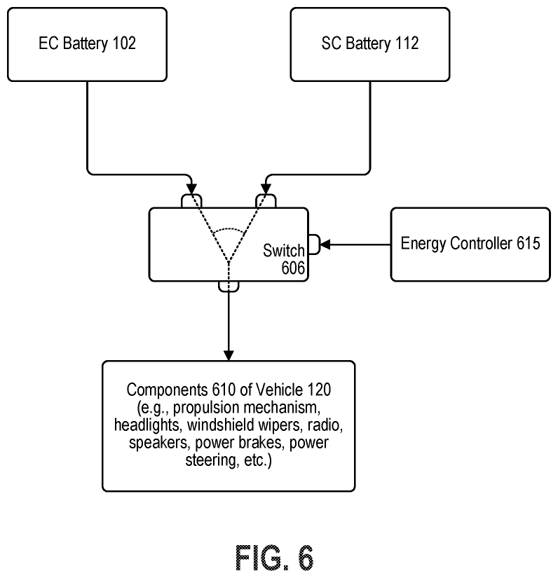

FIG. 6 is a block diagram illustrating a switch 605 controlled by an energy controller 615 that toggles between a first configuration in which components 610 draws power from an electrochemical battery 102 and a second configuration in which the components 610 draw power from a SC battery 112. The components 610 are components of an electric vehicle 120, such as a propulsion mechanism (e.g., engine and/or motor and/or other actuator), headlights, windshield wipers, radio, speakers, power brakes, power steering, display, camera, sensors, and the like. The first configuration is illustrated by a dashed line to the left, connecting the EC battery 102 to the components 610, and disconnecting the SC battery 112 from the components 610. The second configuration is illustrated by a dashed line to the right, connecting the SC battery 112 to the components 610, and disconnecting the EC battery 102 from the components 610. The toggling of the switch 605 between the two configurations can be controlled by the energy controller 615, which can be an example of the energy management system 100, the electrochemical battery 102, the SC adder module 104, the switch and test module 106, the base module 108, the controller 110, the SC batteries 112, the memory 114, the SC controller 116, the database 118, electric vehicle 120, or a combination thereof. The switch 605 can be a mechanical switch, a Single Pole Single Throw (SPST) switch, a Single Pole Double Throw (SPDT) switch, a Double Pole Single Throw (DPST) switch, a Double Pole Double Throw (DPDT) switch, a toggle switch, a transistor switch, an NPN transistor switch, a PNP transistor switch, an H-bridge switch, or a combination thereof.

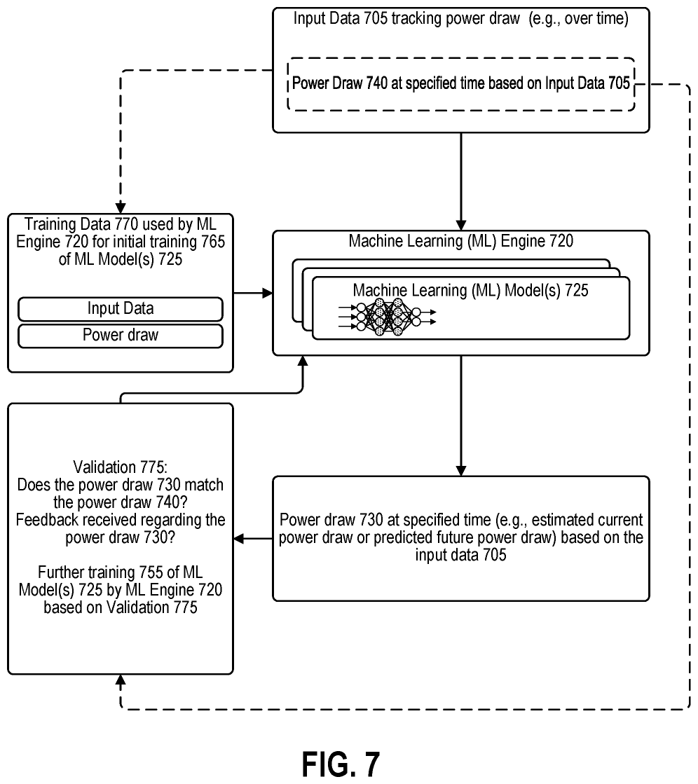

FIG. 7 is a block diagram 700 illustrating use of one or more trained machine learning models 725 of a machine learning engine 720 to identify a power draw 730, for instance to estimate a current power draw or predict a future power draw. The ML engine 720 and/or the ML model(s) 725 can include one or more neural networks (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 7, a graphic representing the trained ML model(s) 725 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 720 and/or the ML model(s) 725 can be part of the AI/ML module 182.

Once trained via initial training 765, the one or more ML models 725 receive, as an input, input data 705 that identifies power drawn by various components and/or subsystems of a system (e.g., of a vehicle), for instance tracking power drawn by various components and/or subsystems of the system (e.g., of the vehicle) over time. In some examples, the input data 705 identifies attribute(s) of charging and/or discharging of an energy storage unit (ESU) (e.g., type, voltage, discharge curve, capacitance, impedance, current, amperage, capacity, energy density, specific energy density, power density, temperature, temperature dependence, service life, physical attributes, charge cycle, discharge cycle, cycle life, deep discharge ability, discharge rate, charge rate, and the like), attribute(s) of the components and/or subsystems of the system (e.g., of the vehicle) that draw charge from the ESU, attribute(s) of the system (e.g., of the vehicle) that includes the ESU and draws charge from the ESU (e.g., mileage, efficiency, ergonomics, aerodynamics, shape, geometry, weight, horsepower, brake power, turning radius, type, size, energy consumption rate, location, speed, velocity, acceleration, deceleration, turning radius, and the like), or a combination thereof.

At least some of the input data 705 may be received from one or more sensors, such as sensors to measure voltage, current, resistance, capacitance, inductance, frequency, power, temperature, continuity, location, motion, acceleration, deceleration, orientation, changes to any of these attributes, or a combination thereof. In some examples, the one or more sensors can include one or more voltmeters, ammeters, ohmmeters, capacimeters, inductance meters, wattmeters, thermometers, thermistors, multimeters, accelerometers, gyrometers, gyroscopes, global navigation satellite system (GNSS) receivers, inertial measurement units (IMUs), or a combination thereof. In some examples, the input data 705 may be received from a one or more databases, such as the database 118, where at least some of the input data 705 may be stored after measurement by the sensors. In some examples, the input data 705 can also include information that is indicative of total capacity of the ESU, the remaining charge and/or remaining capacity of the ESU, a level of shade or shadows that could prevent solar cells from generating charge from light (e.g., whether or not shade or shadows are blocking solar cells to prevent solar charging), a route of the vehicle, a schedule trip of the vehicle, elevation data indicative of uphill and/or downhill portions of a route of the vehicle, or a combination thereof. In some examples, for instance during validation 775, the ML engine 720 and/or the one or more ML models 725 can also receive, as an additional input, a predetermined power draw 740 (e.g., current power draw or predicted future power draw) that is based on (or otherwise corresponds to) the input data 705. In response to receiving at least the input data 705 as an input(s), the one or more ML model(s) 725 estimate the power draw 730 (e.g., current power draw or predicted future power draw) based on the input data 705. The power draw 730 (e.g., current power draw or predicted future power draw) can indicate an amount of power drawn, a rate at which power is drawn, and the like. The power draw can be indicated in terms of voltage, current, resistance, capacitance, inductance, frequency, power, amperage, capacity, energy density, specific energy density, power density, charge cycle, discharge cycle, cycle life, deep discharge ability, discharge rate, charge rate, or a combination thereof. The power draw can be indicated in units of watts, amps, volts, ohms, joules, farads, henries, any of the previously-listed units measured per distance or area (e.g., per meter or per meter squared), any of the previously-listed units measured per unit of time (e.g., per second or per second squared), or a combination thereof.

Identifying the power draw 730 (e.g., estimated current power draw or predicted future power draw) can correspond to at least operations 208, 302, and/or 715. It should be understood that the predetermined power draw 740 can likewise include any of the types of power draw information listed above with respect to the power draw 730.

Once the one or more ML models 725 identify the power draw 730, the power draw 730 can be output to an output interface that can indicate the power draw 730 to a user (e.g., by displaying the power draw 730 or playing audio indicative of the power draw 730) and/or to the energy management system 100 (e.g., the vehicle), which can adjust settings and/or configurations for the energy management system 100 (e.g., the vehicle), for instance, to switch between a first configuration in which components and/or subsystems (e.g., the propulsion system of the vehicle) draw power from an electrochemical battery (and disconnects a supercapacitor from providing power to those components and/or subsystems) and a second configuration in which the components and/or subsystems (e.g., the propulsion system of the vehicle) draw power from a supercapacitor (and disconnects the electrochemical battery from providing power to those components and/or subsystems).

Before using the one or more ML models 725 to identify the power draw 730 the ML engine 720 performs initial training 765 of the one or more ML models 725 using training data 770. The training data 770 can include examples of input data tracking power draw over time (e.g., as in the input data 705) and/or examples of a predetermined power draw (e.g., as in the predetermined power draw 740). In some examples, the pre-determined power draw in the training data 770 are power draw(s) that the one or more ML models 725 previously identified based on the input data in the training data 770. In the initial training 765, the ML engine 720 can form connections and/or weights based on the training data 770, for instance between nodes of a neural network or another form of neural network. For instance, in the initial training 765, the ML engine 720 can be trained to output the pre-determined power draw in the training data 770 in response to receipt of the corresponding input data in the training data 770.

During a validation 775 of the initial training 765 (and/or further training 755), the input data 705 (and/or the exemplary input data in the training data 770) is input into the one or more ML models 725 to identify the power draw 730 as described above. The ML engine 720 performs validation 775 at least in part by determining whether the identified power draw 730 matches the predetermined power draw 740 (and/or the predetermined power draw in the training data 770). If the power draw 730 matches the predetermined power draw 740 during validation 775, then the ML engine 720 performs further training 755 of the one or more ML models 725 by updating the one or more ML models 725 to reinforce weights and/or connections within the one or more ML models 725 that contributed to the identification of the power draw 730, encouraging the one or more ML models 725 to make similar power draw determinations given similar inputs. If the power draw 730 does not match the predetermined power draw 740 during validation 775, then the ML engine 720 performs further training 755 of the one or more ML models 725 by updating the one or more ML models 725 to weaken, remove, and/or replace weights and/or connections within the one or more ML models that contributed to the identification of the power draw 730, discouraging the one or more ML models 725 from making similar power draw determinations given similar inputs.

Validation 775 and further training 755 of the one or more ML models 725 can continue once the one or more ML models 725 are in use based on feedback 750 received regarding the power draw 730. In some examples, the feedback 750 can be received from a user via a user interface, for instance via an input from the user interface that approves or declines use of the power draw 730 for charging the ESU. In some examples, the feedback 750 can be received from another component or subsystem of the vehicle (e.g., an energy control system), for instance, based on whether the component or subsystem successfully uses the power draw 730, whether use the power draw 730 causes any problems for the component or subsystem (e.g., which may be detected using the sensors), whether use the power draw 730 is accurate, or a combination thereof. If the feedback 750 is positive (e.g., expresses, indicates, and/or suggests approval of the power draw 730, success of the power draw 730, and/or accuracy the power draw 730), then the ML engine 720 performs further training 755 of the one or more ML models 725 by updating the one or more ML models 725 to reinforce weights and/or connections within the one or more ML models 725 that contributed to the identification of the power draw 730, encouraging the one or more ML models 725 to make similar power draw determinations given similar inputs. If the feedback 750 is negative (e.g., expresses, indicates, and/or suggests disapproval of the power draw 730, failure of the power draw 730, and/or inaccuracy of the power draw 730) then the ML engine 720 performs further training 755 of the one or more ML models 725 by updating the one or more ML models 725 to weaken, remove, and/or replace weights and/or connections within the one or more ML models that contributed to the identification of the power draw 730, discouraging the one or more ML models 725 to make similar power draw determinations given similar inputs.

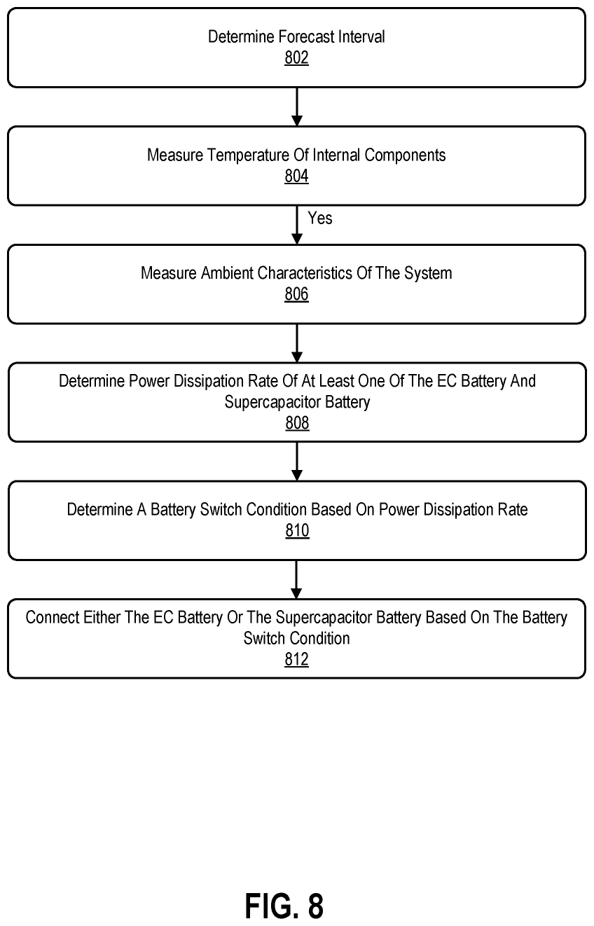

FIG. 8 illustrates an example method 800 for controlling the charging of various electrical power sources. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence. The example method may be performed by an energy management system, such as a controller 110 executing one or modules, such as the base module 108 and the voltage sensor 132.

According to some examples, the energy management system may measure power provided by at least one of the supercapacitor and the electrochemical battery during vehicle operation to propel at least one passenger or object at block 805.

According to some examples, the energy management system may detect a connection of an external charging system to recharge at least one of a supercapacitor and an electrochemical battery at block 810. In some examples, the supercapacitor comprises a plurality of selectable power sources that can be combined to form the supercapacitor. For example, the supercapacitor can include an addressable crossbar matrix switch for addressing each different selectable power sources.

According to some examples, the energy management system may, in response to detecting the connection of the external charging system, determine a fault exists and is associated with at least one of charging or discharging at block 815. In one example, the energy management system may retrieve OBC information from the database to determine whether fault information is stored. For example, the fault information can identify a connection issue based on a transient spike in energy consumption that is outside of the norm. In many cases, these transient spikes can be hard for a rule-based (e.g., purely logical) approach and an ML model can be used to distinguish between anomalous transient spikes and adverse transient spikes. As an example, a bad electrical connection can cause adverse transient spikes when the vehicle experiences a significant vibration. When the database stores information that is indicative of a fault, the supercapacitor is not charged. For example, the fault information may identify an electrical issue within the charging system and charging the supercapacitor could create an adverse safety condition. In some other aspects, the supercapacitor is charged when the fault information is not stored in the database.

There are various approaches for detecting a fault that will be stored, for example, in the database 118. In one aspect, a machine learning model is configured to learn use patterns and adjusts weights based on the usage of the vehicle. In this case, the machine learning model may also be configured to identify an adverse condition, such as a current consumption that may lead to a hazardous condition. Further, the fault may be associated with charging or discharging.

In some examples, the energy management system may retrieve drive data recorded during vehicle operation. The drive data may include measured power provided by at least one of the supercapacitor and the electrochemical battery during the drive. In this case, the energy management system may evaluate the drive data to identify potential transient conditions that may indicate a hazardous condition. For example, the energy management system may determine whether the drive data indicates the fault based on the drive data. As an example, if a current drawn from a power source (e.g., the supercapacitor) is a threshold (e.g., 15%) higher than conventional use suggests for a period of time, the energy management system may determine that an adverse electrical condition exists within the electric powertrain.

According to some examples, the energy management system may, charge the supercapacitor based on whether the fault exists at block 820. For example, when charging the supercapacitor, the energy management system may charge a first portion of the selectable power sources in a first interval and then charge a second portion of the selectable power sources for a second interval. In this example, the first portion of the selectable power sources are configured to not receive power for a delay period after the first interval expires or power associated with the first portion of the selectable power sources exceeds a threshold. The supercapacitor may only allow a portion of the selectable power sources to be recharged after a delay to preserve battery life, reduce heat, and other safety issues associated with electrical energy storage. For example, each selectable power source may be reserved from recharging for a period of time for safety issues. In some examples, the energy management system may elect to charge different sets of the selectable power sources in different periods.

In some cases, a machine learning model identifies the fault based on the current charging rate and the previous charging rates. A rule-based model identifies the fault based on deviation from at least a threshold associated with power charging. For example, if the charging rate, which is an amount of power consumed over a unit time period, exceeds a threshold the charging rate can indicate power is being diverted. For example, the energy management system may measure a current charging rate of the supercapacitor and may compare the current charging rate with previous charging rates of power storage that occurred at different recharging instances. In this case, the machine learning model can take disparate inputs (e.g., temperature, stored power, voltage, etc.) and identify potential hazardous issues. As an example, the energy management system may detect the fault based on a deviation of the current charging rate with the previous charging rates in similar circumstances.

The machine learning model may also model a dynamic impedance of a supercapacitor. In some cases, the equivalent circuit model 500 in FIG. 5 is insufficient to accommodate the changes to the supercapacitor over time, temperature, charging/discharging cycles, and so forth. The machine learning model may also implement an algorithm to select a power delivery source from the EC battery and the SC battery based on a drive profile to minimize power dissipation. Because the number of variables is extensive (time, temperature, voltage, current, drive profile, ambient conditions, etc.), a machine learning model can be trained to select the power source to maximize the lifecycle of the heterogeneous battery system using an optimal power source.

FIG. 8 is a flow diagram illustrating a method 800 to estimate power dissipation at runtime by a device having a heterogeneous battery system in accordance with some aspects of the disclosure. For example, the method 800 may be executed by the energy management system 100 to manage power delivery of the EC battery 102 and the SC batteries 112 to an electric vehicle 120.

In some aspects, at block 802, the method 800 may determine a forecast interval associated with the energy management system. In some cases, the interval may be predetermined (e.g., every 120 seconds) and this operation can be omitted. The forecast interval is a period associated with a prediction that the energy management system can use to manage power. Shorter forecast intervals will be more efficient, but will require additional measurements and computations. In this case, the method 800 may determine a dynamic period to model power consumption.

At block 804, the method 800 measures temperature of internal components of the system. Non-limiting examples of internal components include a temperature of a supercapacitor battery, an EC battery, an ambient temperature of an internal structure that provides ambient cooling to various aspects of a system implementing the energy management system, a temperature of a high power conductive path from a battery, a temperature of a high power relay for coupling the supercapacitor battery or the EC battery, and so forth. In some aspects, temperature affects thermal noise of a conductive path, which increases resistance as temperature of the conductor increases.

At block 806, the method 800 measures ambient characteristics of the system. Non-limiting examples of ambient characteristics include a temperature, luminance, air speed, humidity, weather, and so forth. For example, an ambient characteristic can be rainfall, which may affect the thermal dissipation of various cooling devices.

At block 808, the method 800 determines power dissipation rate of at least one of the EC battery and the supercapacitor battery. In some cases, the power dissipation rate is related to a power consumption profile as modified by environmental information, such as the ambient information and the measured temperature of the internal components. In some aspects, the power dissipation rate can also be affected by the lifecycle of the EC battery and the supercapacitor battery. In one example, the method 800 can execute the DI module (e.g., DI module 128) to determine parasitic modeling information, which is then used to compute the power dissipation rate based on a drive profile.

The method 800 determines a battery switch condition based on the power dissipation rates at block 810. For example, in some cases, the impedance of the supercapacitor may yield a lower power dissipation based on a temperature of the supercapacitor, temperatures within the system, and ambient characteristics.

At block 812, the process connects either the EC battery or the supercapacitor battery based on the battery switch condition being satisfied. In some cases, the battery switch condition comprises a condition for the supercapacitor and a different condition for the EC battery.

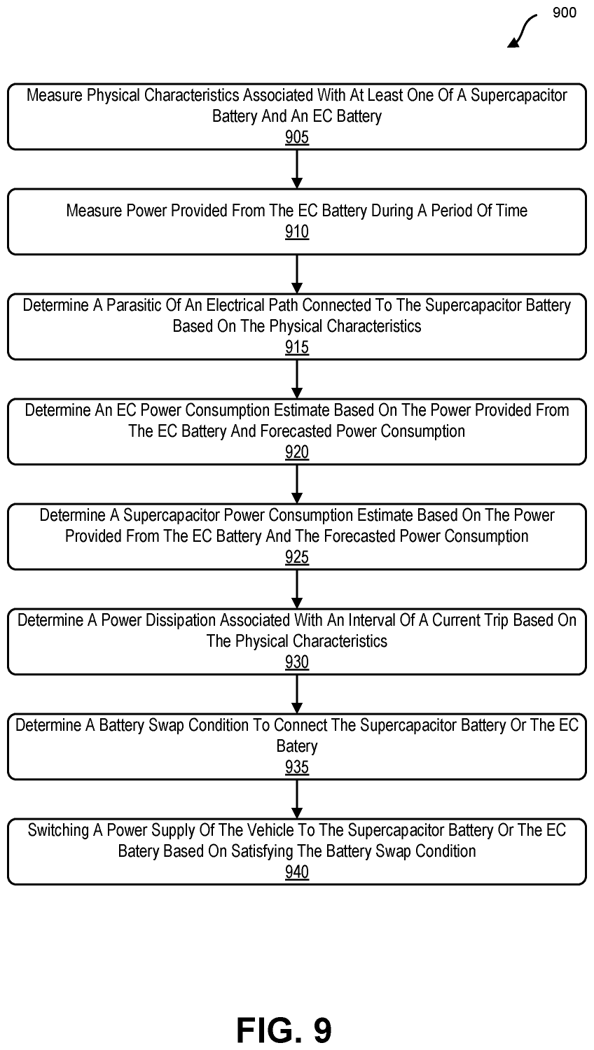

FIG. 9 is a flow diagram illustrating a process 900 executed by a DI module to improve power consumption by a device having a heterogeneous battery system in accordance with some aspects of the disclosure. The process 900 may be performed by, for example, the energy management system 100 to manage power delivery of the EC battery 102 and the SC batteries 112. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method includes measuring physical characteristics associated with at least one of a supercapacitor battery and an EC battery at block 905. For example, the temperatures of the supercapacitor battery, the EC battery, electrical relays, waveguides, electrical wiring, internal cavities, heatsinks, various components, and so forth can be measured.

According to some examples, the method includes measuring power provided from the EC battery during a period of time at block 910.

According to some examples, the method includes determining a parasitic of an electrical path connected to the supercapacitor battery based on the physical characteristics at block 915.

According to some examples, the method includes determining an EC power consumption estimate based on the power provided by the EC battery and forecasted power consumption at block 920. In one aspect, the forecasted power consumption can be an estimate of EC power consumed during a trip, or may be a forecasted power consumption for an interval (e.g., 120 seconds) of the trip.

According to some examples, the method includes determining a supercapacitor power consumption estimate based on the power provided from the EC battery, the forecasted power consumption, and an impedance estimate of the supercapacitor at block 925. For example, the impedance estimate can be associated with the measured physical characteristics and identify a parasitic loss associated with the supercapacitor at that point in time.

According to some examples, the method includes determining a power dissipation associated with an interval of a current trip based on the physical characteristics at block 930. According to various aspects, the power dissipation current trip can significantly vary based on a large number of factors. For example, frequent acceleration or deceleration can consume significant energy as compared to cruising. However, in some cases, frequency acceleration or deceleration at lower speeds (e.g., 30 miles per hour) can incur significantly less energy than at higher speeds. In some aspects, the driving profile includes an average time of deceleration, an average time of acceleration, an average time of a cruising speed, and an average speed.

Further, the determining a power dissipation associated with an interval of a current trip comprises determining a parasitic of the supercapacitor battery based on the physical characteristics associated with the driving profile. In some aspects, the parasitic of the supercapacitor battery can be a volume of data that represents total change over the interval and can be used to determine optimal power dissipation. For example, the determining of the power dissipation may include estimating a thermal dissipation of the at least one of the supercapacitor battery and an electrical path connected to the EC battery based on the driving profile.

Further, the method comprises updating an impedance model based on a thermal dissipation rate and various measurements. For example, the method may include updating data associated with a passive loss of at least one of the supercapacitor battery and the electrical path. For example, the passive loss may be determined by a resistance and a complex impedance in an equivalent circuit model. In some cases, the frequency components of the equivalent circuit model (e.g., the inductor and the complex impedance) may also affect various operations, such as changing a voltage. Changing the voltage can create a frequency component that could affect performance at least temporarily.

At block 935, the method determines a battery swap condition to connect the either the supercapacitor battery or the EC battery based on the physical characteristics. Other information may be used to determine the battery swap condition, such as the driving profile of the current trip. The battery swap condition can be a supercapacitor battery condition, corresponding to providing power using the supercapacitor, and an EC battery condition, corresponding to providing power using the EC battery. In this case, the EC is connected to the system, and the supercapacitor battery is connected (and the EC battery disconnected) when the supercapacitor battery swap condition is satisfied. In this case, the power dissipation is optimized for power delivery from the supercapacitor based on the impedances associated with the supercapacitor battery. When the supercapacitor battery is connected and the EC battery swap condition is satisfied, the conditions are favorable for the EC battery, and the EC battery is connected to power the system. In one illustrative example, the EC battery swap condition may be a threshold voltage associated with the supercapacitor, such as a percentage of voltage drop (e.g., 20%).

At block 940, the method includes switching a power supply of the vehicle to the supercapacitor battery based on satisfying the battery swap condition in block 935. For example, the system can select the EC battery or the supercapacitor battery based on favorable power conditions. In this case, the method configures the system for optimal power withdrawal from the heterogeneous battery system based on a driving profile, parasitics, and lifecycle of the batteries. The DI module allows configures the system to withdraw power dynamically over the lifecycles of the heterogenous battery system in a manner and further tunes an ML model associated with the impedance of the heterogenous battery system to account for environment specific changes.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Aspects of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, aspects of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method for providing power to a vehicle, comprising:
measuring physical characteristics associated with at least one of a supercapacitor battery and an EC battery;
measuring power provided from the EC battery during a period of time;
determining an EC power consumption estimate based on the power provided from the EC battery and forecasted power consumption;
determining a supercapacitor battery swap condition to connect the supercapacitor battery based on an impedance model of the supercapacitor battery associated with the physical characteristics; and
switching a power supply of the vehicle to the supercapacitor battery based on satisfying the supercapacitor battery swap condition.

2. The method of claim 1, further comprising:
determining a supercapacitor power consumption estimate based on the power provided from the EC battery and the forecasted power consumption.

3. The method of claim 2, further comprising:
determining a power dissipation associated with an interval of a current trip based on the physical characteristics.

4. The method of claim 3, further comprising:
determining a driving profile associated the current trip;
estimating a thermal dissipation of the at least one of the supercapacitor battery and an electrical path connected to the EC battery based on the driving profile.

5. The method of claim 4, further comprising:
updating the impedance model based on a thermal dissipation rate.

6. The method of claim 5, wherein updating the impedance model comprises updating a passive loss of at least one of the supercapacitor battery and the electrical path.

7. The method of claim 4, wherein the driving profile includes an average time of deceleration, an average time of acceleration, an average time of a cruising speed, and an average speed.

8. The method of claim 1, further comprising:
determining a parasitic of the supercapacitor battery based on the physical characteristics.

9. The method of claim 1, further comprising:
determining a parasitic of an electrical path connected to the supercapacitor battery based on the physical characteristics.

10. The method of claim 1, wherein the supercapacitor battery swap condition corresponds to a point at which a power dissipation rate of an EC battery is greater than a power dissipation rate of an SC battery based on an estimated driving interval.

11. The method of claim 1, further comprising:
determining an EC battery swap condition to connect the EC battery based on a model of the EC battery associated with the physical characteristics; and
switching the power supply of the vehicle to the EC battery based on satisfying the EC battery swap condition.

12. The method of claim 11, wherein the EC battery swap condition corresponds to a measured voltage of the supercapacitor battery.

13. An electric vehicle comprising:
an electric drivetrain configured to propel the vehicle;
a plurality of energy storage units including a supercapacitor and an electrochemical battery;
a storage configured to store instructions;
a processor configured to execute the instructions and cause the processor to:
measure physical characteristics associated with at least one of the supercapacitor battery and the EC battery;
measure power provided from the EC battery during a period of time;
determine an EC power consumption estimate based on the power provided from the EC battery and forecasted power consumption;
determine a supercapacitor battery swap condition to connect the supercapacitor battery based on an impedance model of the supercapacitor battery associated with the physical characteristics; and
switch a power supply of the vehicle to the supercapacitor battery based on satisfying the supercapacitor battery swap condition.

14. The electric vehicle of claim 13, wherein the processor is configured to execute the instructions and cause the processor to:
determine a supercapacitor power consumption estimate based on the power provided from the EC battery and the forecasted power consumption.

15. The electric vehicle of claim 14, wherein the processor is configured to execute the instructions and cause the processor to:
determine a power dissipation associated with an interval of a current trip based on the physical characteristics.

16. The electric vehicle of claim 15, wherein the processor is configured to execute the instructions and cause the processor to:
determine a driving profile associated the current trip;
estimate a thermal dissipation of the at least one of the supercapacitor battery and an electrical path connected to the EC battery based on the driving profile.

17. The electric vehicle of claim 16, wherein the processor is configured to execute the instructions and cause the processor to:
update the impedance model based on a thermal dissipation rate.

18. The electric vehicle of claim 17, wherein updating the impedance model comprises updating a passive loss of at least one of the supercapacitor battery and the electrical path.

19. The electric vehicle of claim 16, wherein the driving profile includes an average time of deceleration, an average time of acceleration, an average time of a cruising speed, and an average speed.

20. The electric vehicle of claim 13, wherein the processor is configured to execute the instructions and cause the processor to:
determine a parasitic of the supercapacitor battery based on the physical characteristics.
